(19) United States
(12) Patent Application Publication
(10) Pub. No.: US 2022/0283374 A1
(43) Pub. Date: Sep. 8, 2022

(54) METHODS FOR PROCESSING FIBER OPTIC CABLES

(71) Applicant: COMMSCOPE TECHNOLOGIES LLC, Hickory, NC (US)

(72) Inventors: Mandy Lea TRNKA, Lonsdale, MN (US); Jaime GONZALEZ BATISTA, Prior Lake, MN (US); Scott L. CARLSON, Bloomington, MN (US)

(73) Assignee: COMMSCOPE TECHNOLOGIES LLC, Hickory, NC (US)

(21) Appl. No.: 17/630,393

(22) PCT Filed: Jul. 22, 2020
(86) PCT No.: PCT/US2020/043111

§ 371 Date: Jan. 26, 2022

Related U.S. Application Data
(60) Provisional application No. 62/879,244, filed on Jul. 26, 2019.

(51) Int. Cl. G02B 6/255; G02B 6/245

(52) U.S. Cl. CPC G02B 6/2555; G02B 6/245

(57) ABSTRACT

The present disclosure relates generally to a method for processing an optical fiber. The coating is stripped from the cladding of the optical fiber using a stripping process. Direct heat is applied to the first side of the optical fiber and is not applied to the second side of the optical fiber. Then, the optical fiber is inserted into a fiber alignment structure with the second side of the optical fiber engaging a fiber alignment feature of the alignment structure. The first side of the optical fiber does not engage the fiber alignment feature.

### CROSS-REFERENCE TO RELATED APPLICATION

This application is being filed on Jul. 22, 2020 as a PCT International Patent Application and claims the benefit of U.S. Patent Application Ser. No. 62/879,244, filed on Jul. 26, 2019, the disclosure of which is incorporated herein by reference in its entirety.

### TECHNICAL FIELD

The present disclosure relates generally to methods for processing fiber optic cables. More particularly, the method is directed towards methods of stripping and connecting optical fibers.

### BACKGROUND

Fiber optic communication systems are prevalent in part because service providers want to deliver high band width communication capabilities (e.g. data and voice) to customers. Fiber optic communication systems employ a network of fiber optic cables to transmit large volumes of data and voice signals over relatively long distances. Optical fibers may be connected by splicing or through the use of connectors.

Optical fibers that are currently commercially available comprises a central glass core, a glass cladding that surrounds the core, and a coating of synthetic polymer material, such as acrylate. Typically, the external diameter of the cladding is about 125 μm and the external diameter of the polymer coating is approximately 250 μm, or approximately 200 μm. The coating is provided to protect the inner core and glass cladding from the external environment.

### SUMMARY

It is often necessary to remove the coating of synthetic polymer material from the optical fibers. Heat is often applied to remove the coating; however, residue of the coating often remains on at least a portion of the glass cladding of the optical fiber. The residue left behind can cause inaccurate and imprecise splicing or requires further processing of the optical fiber.

Aspects of the present disclosure relate to methods for handling, positioning, and aligning optical fibers in which imprecision related to residue adhesive can be reduced or eliminated.

Another aspect relates to a method for processing an optical fiber having a coating surrounding the cladding and the core. The optical fiber includes a first side and an opposing second side. The method includes stripping the coating from the cladding of the optical fiber using a stripping process. The stripping process includes applying direct heat to the first side of the optical fiber and not applying direct heat to the second side of the optical fiber. After stripping, the optical fiber is inserted into a fiber alignment structure with the second side of the optical fiber engaging a fiber alignment feature of the alignment structure and the first side of the optical fiber not engaging the fiber alignment feature. In this way, coating residue at the first side of the fiber does not negatively impact fiber alignment.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements;

FIG. 1 illustrates an example method of processing an optical fiber;

FIG. 2 illustrates a top view of a stripping device;

FIG. 3 illustrates a cross-sectional view of the optical fibers within the stripping device;

FIG. 4 illustrates a cross-sectional view of the optical fibers within a fiber alignment structure;

FIGS. 5-7 illustrate an example embodiment of a clip useful to process the optical fiber;

FIG. 8 illustrates an alternative example of a fiber alignment structure;

FIGS. 9A-9B illustrate an example embodiment of a splicing device;

FIG. 10 is a top view of an example clip for facilitating handling and processing optical fibers in accordance with the principles of the present disclosure, the clip is shown in a closed configuration;

FIG. 11 is a top view of the clip of FIG. 10 in an open configuration;

FIG. 12 is a top view showing a top side of the clip of FIG. 10;

FIG. 13 is a bottom view showing a bottom side of the clip of FIG. 10;

FIG. 14 shows the clip of FIGS. 10-13 with the bottom side of the clip received within a nest of a hot stripping machine;

FIG. 15 shows the hot stripping machine of FIG. 14 retrofitted with an insert installed within the nest, the insert is configured such that the nest can receive the top side of the clip of FIGS. 10-13 and not the bottom side of the clip of FIGS. 10-13;

FIG. 16 shows the retrofitted hot stripping device of FIG. 15 with the topside of the clip of FIGS. 10-13 mated within the retrofitted nest of the hot stripping device; and

FIG. 17 depicts a fusion splicing machine having nests for receiving the bottom sides of fiber holding clips each having a configuration of the type shown at FIGS. 10-13.

### DETAILED DESCRIPTION

Aspects of the present disclosure relate to methods for processing optical fibers, and ensuring that the alignment in a fiber alignment structure is precise.

Generally, the method includes placing a first side of an optical fiber in heated contact with a stripping device, and after stripping, placing a second side of the optical fiber in contact with a fiber alignment structure, such as an alignment structure of a splicing device. A further process includes stripping the coating from the cladding of the optical fiber using a stripping process. The stripping process includes applying direct heat to the first side of the optical fiber and not applying direct heat to the second side of the optical fiber. Then, after stripping, the optical fiber is inserted into a fiber alignment structure with the second side of the optical fiber engaging a fiber alignment feature of the alignment structure.

When optical fibers are stripped a majority of the coating layer is removed. However, residue of the coating layer can remain on the optical fiber, which can cause misalignment in a fiber alignment structure. In an example embodiment, a fiber alignment structure may be integrated with a splicing device. In another example embodiment, a fiber alignment structure is a ferrule.

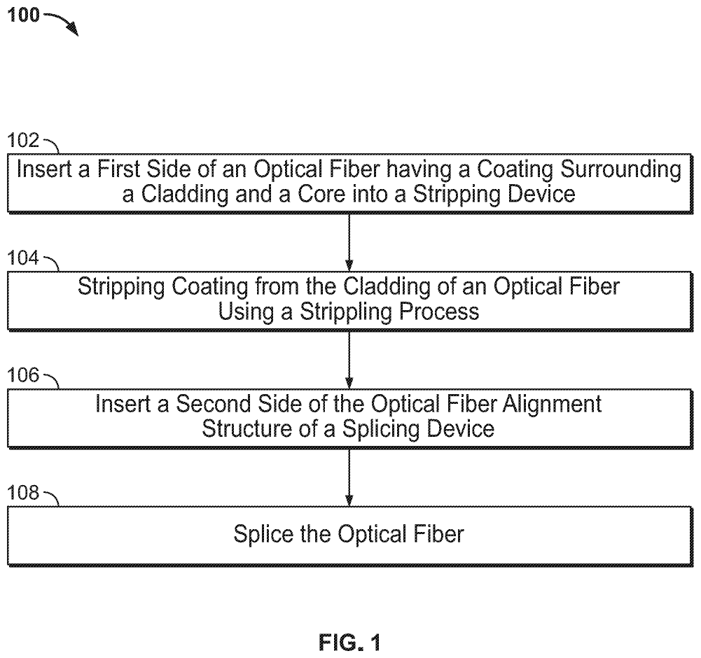

FIG. 1 illustrates an example method 100 for processing at least one optical fiber according to embodiments herein. The optical fiber can have a polymer coating, such as acrylate, surrounding a cladding and a core. The optical fiber also can have a first longitudinal side and an opposing second longitudinal side.

At operation 102, the at least one optical fiber is inserted into a stripping device. The stripping device includes a heater that applies direct heat to the first side of the at least one optical fiber, but does not apply direct heat to the second side of the at least one optical fiber.

At operation 104, the polymer coating is stripped from the cladding of the at least one optical fiber. During stripping, it is desirable to remove as much of the coating as possible. However, coating residue can remain on the cladding after stripping. Commonly, due to direct heating and pressure, more residue is left on the first side of the optical fiber as compared to the second side of the optical fiber.

At operation 106, the at least one optical fiber is inserted into a fiber alignment structure. The fiber alignment structure may be part of a splicing device, the fiber alignment structure may be part of a ferrule, or may be part of another component or piece of equipment. In certain examples, the alignment device can include a mechanical alignment feature such as a groove (e.g., a V-groove). The second side of the at least one optical fiber, which has no residue or less residue than the first side, is engaged with the fiber alignment feature of the alignment structure. For example, the cladding of the second side of the at least one optical fiber faces the fiber alignment feature and preferably engages the fiber alignment feature. The first side of the at least one optical fiber does not necessarily engage or face the fiber alignment feature.

At optional operation 108, the at least one optical fiber is spliced by a splicing device such as a fusion splicer that heats the ends of aligned optical fibers to fuse the ends together.

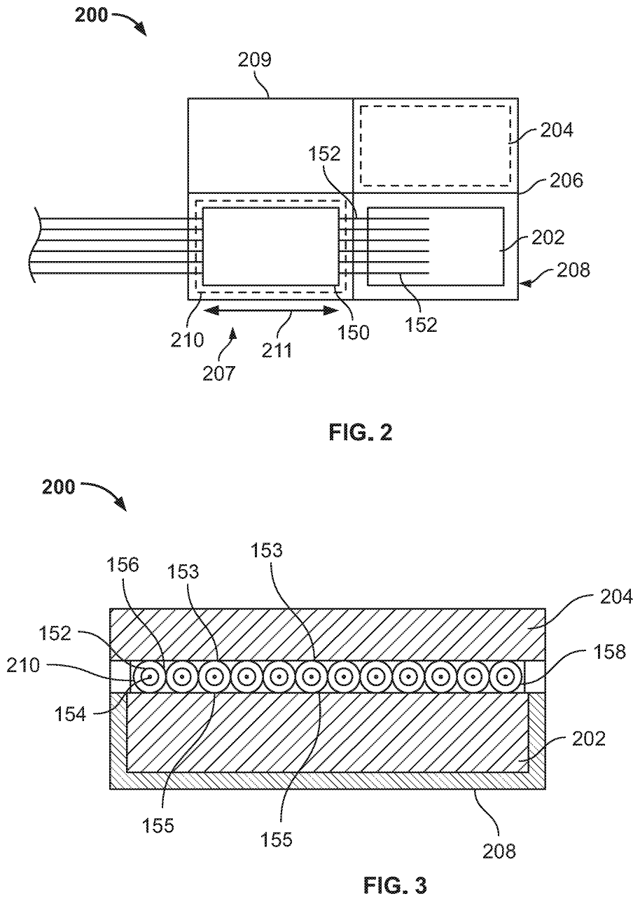

FIG. 2 illustrates an example stripping device 200 that executes the stripping process. A stripping device 200 includes a base 208 and a lid 204 connected at a hinge 206. The base 208 includes a heating element 202 that is capable of applying direct heat to one side of at least one optical fiber 152. The stripping device 200 also includes a clip holder 207 including a pocket 210 (e.g., a nest) that is configured to mate with an interface of a clip 150 holding the at least one optical fiber 152. The lid 204 rotates at the hinge 206 to hold the at least one optical fiber 152 against the base 208 and the heating element 202. The clip holder 207 also includes a lid/cover 209 that can be pivoted closed to hold the clip in the pocket 210. The clip holder 207 is connected to the base 208 by a linear bearing that allows the clip holder 207 to slide along orientation 211 relative to the base 208. In use, the clip is loaded into the clip holder 207 and the clip holder 207 is positioned adjacent the base 208 so that the coated fiber lay over the heating element. The covers are then closed and the heating element is actuated while the coated fiber is pressed against the heating element by the lid 204. After heating, the clip holder 207 is slid away from the base 208 along orientation 211 causing the heated coating to be stripped from the fiber. In some examples, the coating can also be mechanically scored.

The heating element 202 is located at the base 208 of the stripping device 200. Therefore, only a first side of the at least one optical fiber 152 is subject to direct heat provided by the heating element 202. A residue of coating may be left on the cladding of the at least one optical fiber 152 on the first side.

The clip 150 as shown, holds a plurality of optical fiber 152 in a parallel array so that the array of fibers is heated and stripped. In another embodiment, the clip 150 may only hold a single optical fiber 152. The clip 150 is configured to engage with the pocket 210 of the stripping device 200 and can be configured to engage with the pocket of a splicing machine.

FIG. 3 illustrates a cross-sectional view of the stripping device 200 having a plurality of optical fibers 152 located therein. The stripping device 200 includes the base 208 having a heating element 202. The lid 204 presses the optical fibers 152 against the heating element 202 with the first sides of the optical fibers 152 facing toward and engaging the heating element 202.

As indicated above, the clip 150 holds the plurality of optical fibers 152. The clip 150 is configured to be mounted in the pocket 210 of the stripping device 200. In a first embodiment, only one side of the clip 150 is configured to be able to mount in the pocket 210. In another embodiment, the pocket 210 may include an insert that is configured to allow only one side of the clip 150 to be mounted within the insert. The insert can be configured as an adapter that allows the clip 150 to be mounted in the pocket 210 only with the first side facing the pocket 210. The first side of the clip 150 can correspond to the first side 153 of the optical fiber 152 and the second side of the clip 150 can correspond to the second side 155 of the optical fiber 152. The first and second sides of the clip 150 can face opposite directions.

Referring to FIG. 3, each optical fiber 152 includes a core 154 surrounded by a cladding 156, which is surrounded by a coating 158. The heating element 202 heats the optical fibers 152 to facilitate the removal of the coatings 158 from the optical fibers 152. First sides 153 of the optical fibers 152 are subject to direct heat from the heating element 202, while the opposite second sides 155 of the optical fibers 152 face the lid 204, and are not subject to the direct heat applied by the heating element 202.

Once heated, the coatings can be pulled axially from the optical fibers 152 as part of the stripping process. After stripping, the coating residue is more likely to be present at the first sides 153 of the optical fibers 152 due to the direct heating.

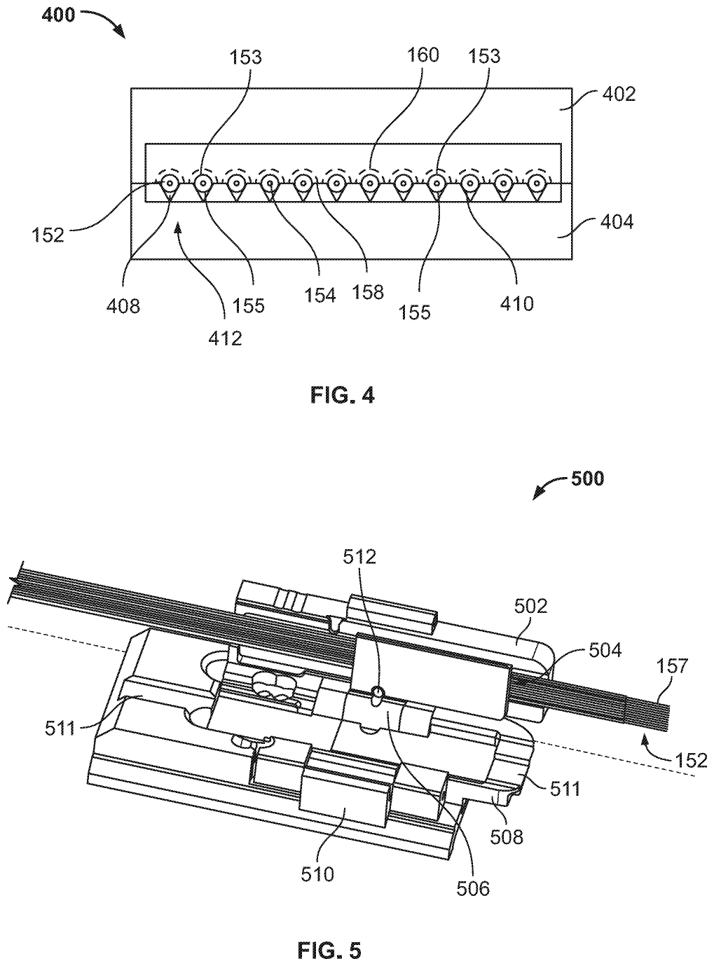

FIG. 4 illustrates a cross-sectional view of a fiber alignment structure 412 in a piece of equipment such as a splicing device 400. The alignment structure 412 includes a base 404 and a lid 402. The lid 402 can be opened to allow optical fibers 152 to be inserted therein.

The base 404 includes the fiber alignment structure 412. In the embodiment shown, the fiber alignment structure 412 includes a plurality of channels 408 that are configured to receive the plurality of optical fibers 152. In an example embodiment, the channels 408 are each shaped as a V-groove. In alternative embodiments the shape of the channels 408 may be different, such as having a C-shape or other similar shape configured to receive an align an optical fiber 152. The plurality of channels 408 are sized to accept the core 154 and the cladding 156 of the optical fiber 152. In use, after the optical fibers 152 have had the coating 158 removed, the coating 158 is only fully or mostly removed from a second side 155 of the optical fiber 152. The second side 155 of the optical fiber 152 is inserted into the plurality of channels 408, so that the cladding 156 touches a sidewall 410 of the plurality of channels 408.

FIGS. 5-7 illustrate an example clip 500 usable in the stripping device 200 and the splicing device 400. The clip 500 includes at least a bottom portion 508, a top portion 502, and a holder 504. The holder 504 attaches to the top portion 502 by a set screw 512. A spacing between the holder 504 and the top portion 502 can be adjusted at the set screw 512 to correspond to the diameter of the coated optical fibers 152 intended to be loaded therein. The optical fibers 152 can be loaded in a row in a region between the holder 504 and the top portion 502. The set screw 512 also attaches the holder 504 and the top portion 502 to a pivot member 506 that pivotably couples the holder 504 and the top portion 502 to the bottom portion 508. The pivot member 506 allows the holder 504 and the top portion 502 to be pivoted together relative to the bottom portion 508 between open and closed positions about pivot axis 507. The bottom portion 508 defines a pocket that receives the holder 504 when the clip 500 is pivoted closed. The optical fibers 152 have ends 157 that project outwardly from the clip 500 so as to be presented for processing when the clip 500 is loaded into a piece of equipment such as a stripper or a splicer. A fiber receiving channel 511 extends axially through the clip 500. The channel 511 is defined by the bottom portion 508.

The distance between the holder 504 and the top portion 502 may be changed as needed, based on the diameter of the optical fibers 152. After the optical fibers 152 have been secured between the holder 504 and the top portion 502, the top portion 502 is closed and is secured against the bottom portion 508 by a latch 510.

In an embodiment, the top portion 502 has an interface that is capable of mating with the stripping device 200, while the bottom portion 508 has an interface that is capable with mating with the fiber alignment structure, for example, the splicing device 400, or vice versa. In another embodiment, the interface of the top portion 502 and interface of the bottom portion 508 are the same, and are each capable of mating with the stripping device and the fiber alignment structure.

The clip 500 can be designed, in concert with the pocket of the stripping device and a pocket of a splicing device, such that the first side mates with the pocket of at least one of the stripping device and the splicing device, and the second side mates with the pocket of at least the other of the stripping device and the splicing device. Thus, the clip 500 can be flipped over when transferred between the pockets of the stripping and splicing devices. For example, the first side can be received in the pocket of the stripping device and the second side can be received in the pocket of the splicing device. In certain examples, the pockets and the clip 500 are configured so that the first side of the clip 500 fits within the pocket of only one of the stripping and splicing devices, and the second side of the clip 500 fits within the pocket of only the other of the stripping and splicing devices. Thus, flipping of the clip 500 is required. By flipping the clip 500, the sides of the optical fibers that are heated during stripping face away from the alignment structure of the splicing device.

In certain examples, the pockets can be initially designed to be compatible with the first or second sides of the clip 500. In other examples, inserts can be used in the pockets to make the pocket of the stripping device compatible with the first side of the clip and not compatible with the second side of the clip, and to make the pocket of the splicing device compatible with the second side of the clip and not the first side of the clip.

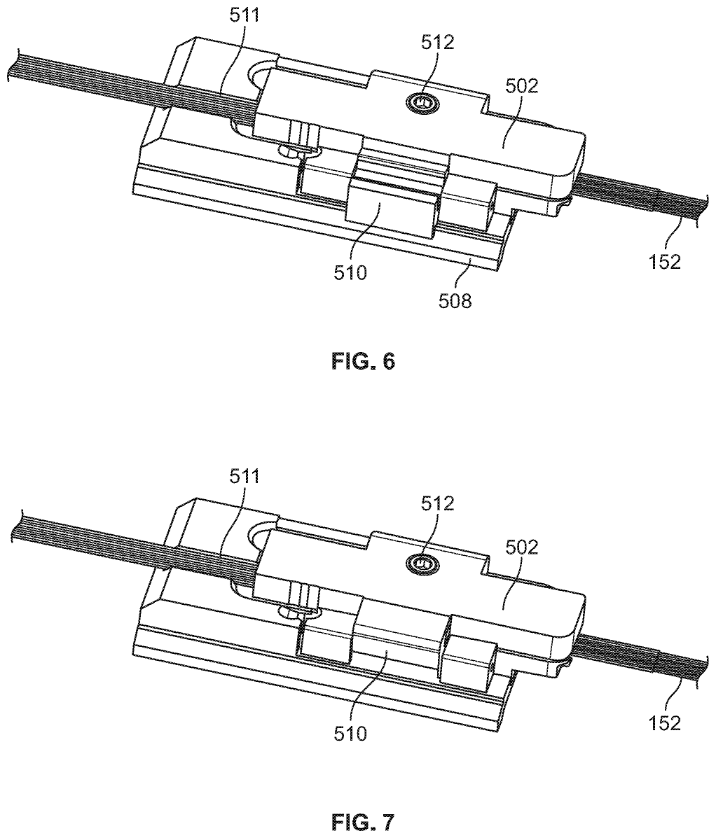

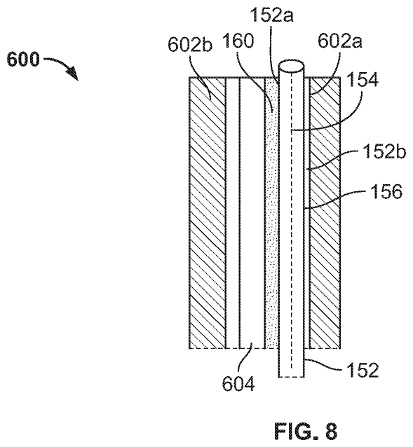

FIG. 8 illustrates an enlarged view of an example fiber alignment structure 600. The fiber alignment structure 600 may be a ferrule that holds at least one optical fiber 152. The ferrule includes an opening 604 having two opposing sides 602a, 602b. The optical fiber 152 is placed in the opening 604, and is biased towards one side 602a. As shown, the second side 152b of the fiber is biased towards the side 602a, so the cladding 156 abuts the side 602a. There may be residue 160 on the first side 152b of the optical fiber 152 that is facing the side 602b. Thus, by biasing the second side of the optical fiber 152 against one side of the opening, any variability in fiber positioning with the ferrule, related to the fiber residue, can be reduced. It will be appreciated that the opening 604 is preferably oversized. However, the oversized nature of the opening 604 is greatly exaggerated at FIG. 6 for illustration purposes.

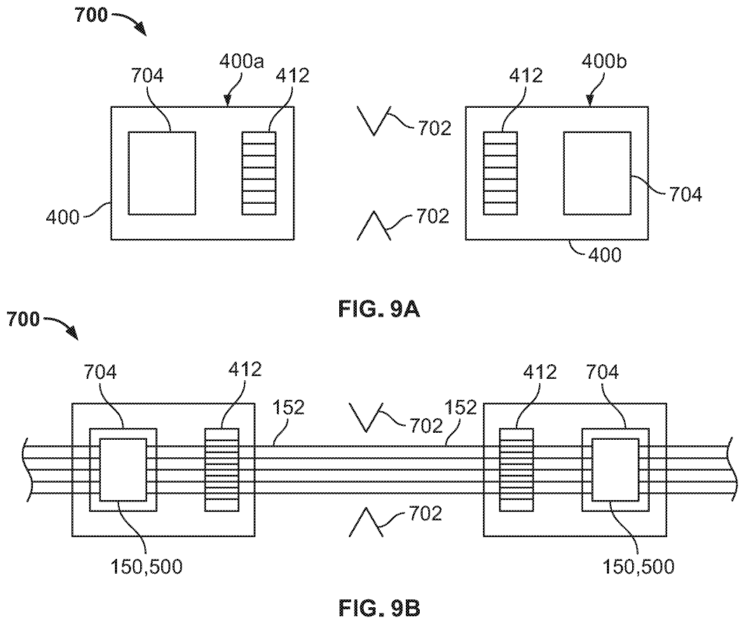

FIG. 9A illustrates an example splicing machine 700 having a first and second sections 400a, 400b. Each section 400a, 400b includes a base 404. The bases 404 each include a clip pocket 704 and a fiber alignment structure 412. Covers or biasing structures can be used to press the optical fibers 152 into the parallel grooves of the alignment structures 412. The optical fibers supported by section 400b are coaxially aligned with optical fibers supported by section 400a and meet at an intermediate fusion splice zone located between the sections 400a, 400b. Electrodes 702 for generating a plasma arc are positioned between the alignment structures 412 and are used to splice together the optical fibers which have tips coaxially aligned at the region between the alignment structures 612. The clip pockets 704 are configured to hold the clips 850 or 500. The clip pockets 704 may accept both sides of the clips, or may only accept one side of each clip.

FIG. 9B illustrates the splicing machine 700 with clips 150, 500 mounted in the clip pockets 704 and optical fiber 152 held by the clips having tips coaxially aligned at the region between the electrodes 712.

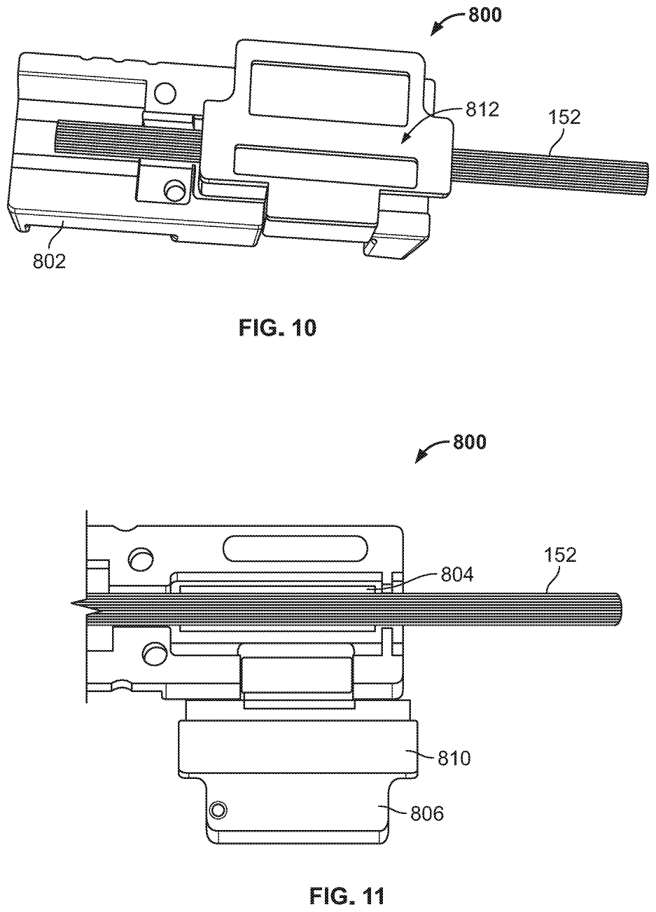

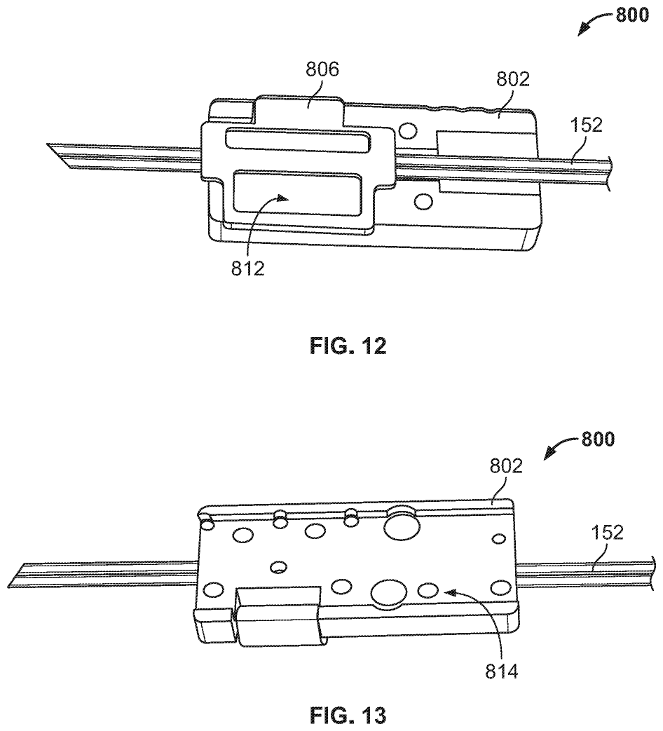

FIGS. 10-13 depict another clip 800 for holding and facilitating handling of a plurality of optical fibers 152. The clip 800 includes a base 802 defining a fiber channel 804 for receiving a plurality of the optical fibers 152 arranged in a ribbon configuration. A cover 806 is mounted to the top of the base 802. The cover 806 is pivotally attached to the base 802 and is movable between a closed position (see FIG. 10) and an open position (see FIG. 11). A resilient pad 810 can be mounted within the cover 806 for holding the optical fibers 152 within the fiber channel 804 when the cover 806 is closed. Magnets can hold the cover 806 closed. The clip 800 includes a top side 812 (shown at FIG. 12) and a bottom side 814 (shown at FIG. 13). The clip 800 has different shapes or profiles at the top side 812 as compared to the bottom side 814.

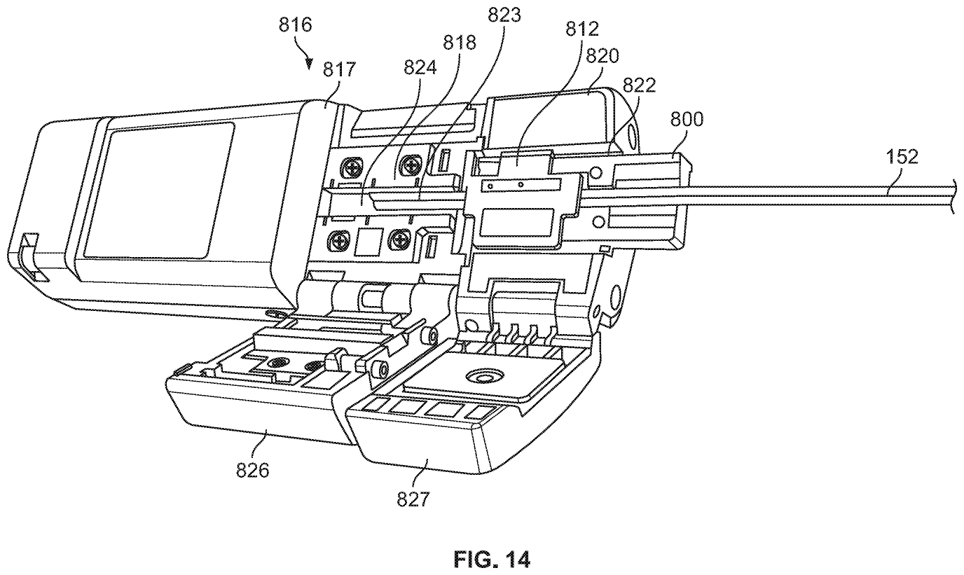

FIG. 14 shows a hot jacket stripper 16 having a main body 817 supporting a heating element 818, and a clip holder 820 connected to the main body 817 by a linear bearing that allows the clip holder 820 to be slid linearly toward and away from the main body 817. The clip holder 820 defines a nest 822 having an interface shape configured to receive the bottom side 814 of the clip 800. FIG. 14 shows the clip 800 mounted within the nest 822 with the bottom side 814 mating with the nest 822 and facing downwardly into the nest, and with the top side 812 facing upwardly. End portions 823 of the optical fibers 152 extend from the clip 800 into a stripping channel 824 defined by the heating element 818. The hot jacket stripper 816 also includes a cover 826 connected to the main body 817 that can be closed to press the end portions 823 of the optical fibers 152 against the heating element 818, and a cover 827 that is closed to press the clip 800 into the nest 822. Once the covers 826, 827 have been closed, the heating element 818 is activated to heat the end portions 823 of the optical fibers. Once the end portions 823 of the optical fibers have been heated, the clip holder 820 is pulled away from the main body 817 on the linear bearings causing the optical fibers to be axially pulled from within the coating surrounding the optical fibers thereby providing a stripping action. The stripped coatings remain within the heating element 818 and are later discarded.

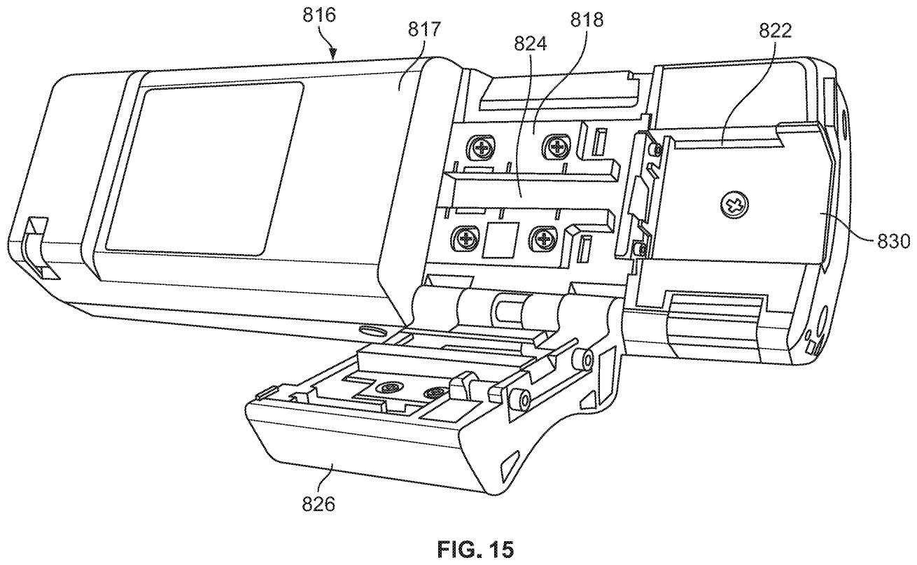

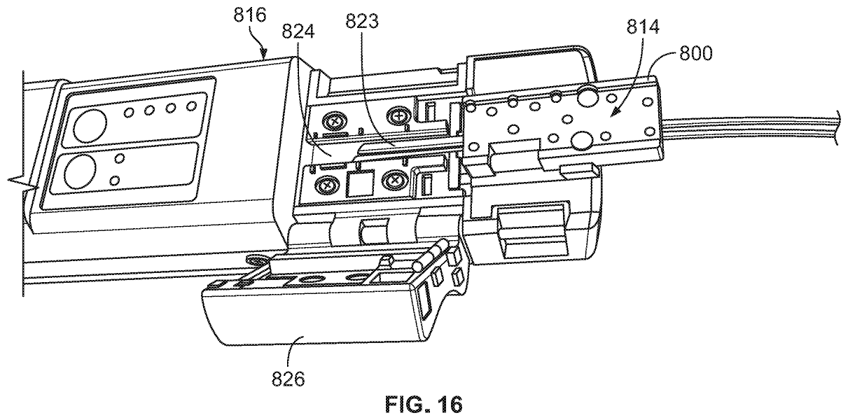

Aspects of the present disclosure relate to modifying or retrofitting the nest 822 of the hot jacket stripper 816 such that the nest 822 is no longer compatible with the bottom side 814 of the clip 800, but instead is compatible with the top side 812 of the clip 800. As shown at FIG. 15, insert 830 is secured within the nest 822. The insert 830 has a mechanical interface shape that is compatible with the top side 812 of the clip 800 and is configured to receive the top side 812 of the clip 800. In a preferred example, the mechanical interface shape or profile of the insert 830 is not compatible with the bottom side 814 of the clip 800 and thereby prevents a technician from installing the clip 800 in the nest 822 with the bottom side 814 facing downwardly into the nest 822. Instead, the clip 800 must be installed with the bottom side 814 of the clip 800 facing outwardly from the nest 822 as shown at FIG. 16 and with the top side 812 received within the nest as shown at FIG. 16. As retrofitted, the hot jacket stripper 816 provides a stripping action in the same manner as previously described.

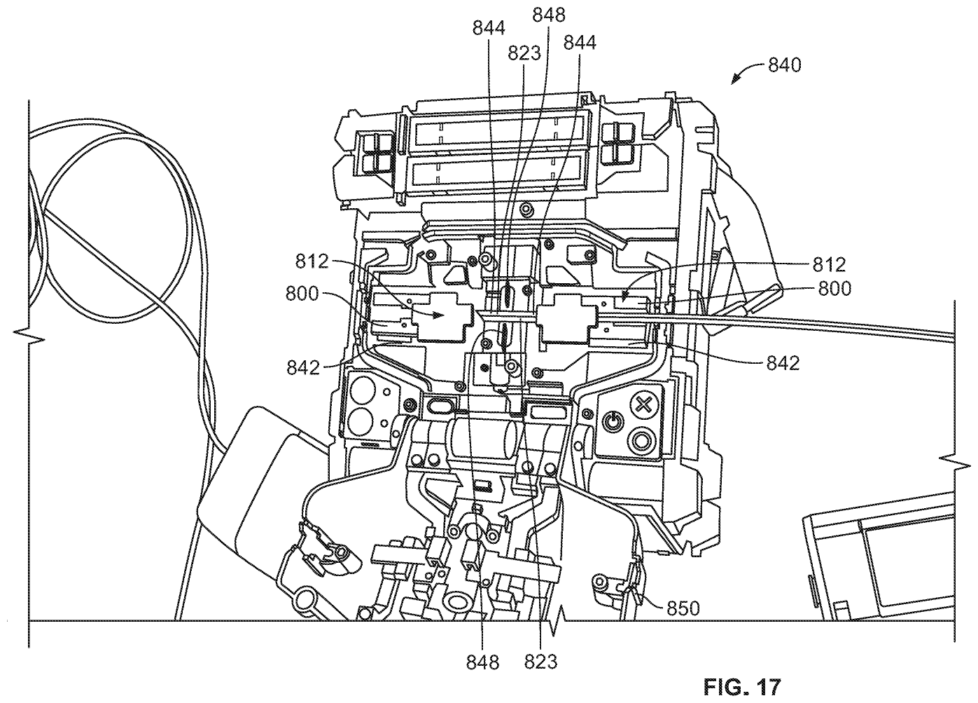

FIG. 17 shows a splicing machine 840 configured to splice together rows of optical fibers each held by a separate one of the clips 800 after the optical fibers held by the clips 800 have been stripped by the retrofitted hot jacket stripper of FIGS. 15 and 16. The splicing machine 840 includes nests 842 configured for receiving the clips 800. Preferably, nests 842 have mechanical interface profiles adapted to receive the bottom sides 814 of the clips 800, and not receive the top sides 812 of the clips 800. Thus, a technician is required to install the clips 800 in the nests 842 with the bottom sides 814 facing downwardly and the top sides 812 facing upwardly. In this way, the clips 800 are flipped in an opposite orientation within the splicing machine 840 as compared to the orientation of the clips when the clips are installed within the retrofitted hot jacket stripper 816 of FIGS. 15 and 16.

The splicing machine 840 also includes alignment structures 844 such as v-grooves for aligning the end portions 823 of the optical fibers held by the clips 800 at a splicing region defined between electrodes 848. The splicing machine 840 also includes a cover 850 that can be closed to press the end portions 823 of the optical fibers 152 into alignment grooves of the alignment structures 844 and to hold the clips 800 within the nests 842 when the electrodes 848 are activated to fusion splice the ends of the optical fibers together. The different configurations of the retrofitted nests of the hot jacket stripper 816 of FIGS. 15 and 16 and the nests 842 of the splicing machine 840 ensures that the technician is required to flip over the clips 800 when the clips are transferred from the stripping station to the splicing station. In this way, it is ensured that the sides of the optical fibers that faced directly toward the heating element 818 during stripping will face away from the alignment grooves of the alignment structures 844 during fusion splicing. In this way, any residual coating remaining on the first sides of the optical fibers will not compromise or negatively affect alignment that takes place at the splicing machine 840.

Embodiments of the present invention, for example, are described above with reference to block diagrams and/or operational illustrations of methods and systems according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method for processing an optical fiber having a coating surrounding a cladding and a core of the optical fiber, the optical fiber including a first side and an opposite second side, the method comprising:
stripping the coating from the cladding of the optical fiber using a stripping process in which direct heat is applied to the first side of the optical fiber and is not applied to the second side of the optical fiber;
inserting the optical fiber, after stripping, into a fiber alignment structure with the second side of the optical fiber engaging a fiber alignment feature of the alignment structure and the first side of the optical fiber not engaging the fiber alignment feature.

2. The method of claim 1, wherein the fiber alignment feature is a fiber alignment groove.

3. The method of claim 2, wherein the fiber alignment groove is a v-groove and the second side of the optical fiber faces toward the v-groove and engages groove-defining surfaces of the v-groove.

4. The method of claim 2 or 3, wherein the fiber alignment structure is used to mechanically align the optical fiber within a splice machine.

5. The method of claim 1, wherein the fiber alignment structure is a ferrule defining a fiber opening for receiving the optical fiber, wherein the fiber alignment feature is an internal surface of the ferrule which defines the fiber opening, and wherein the optical fiber is offset within the fiber opening to one side of the fiber opening such that the second side of the optical fiber engages the internal surface of the ferrule.

6. The method of claim 4, wherein the optical fiber is held by a clip during stripping and splicing, wherein the optical fiber projects outwardly from the clip, wherein the clip includes a first side that faces in the same direction as the first side of the optical fiber and a second side that faces in the same direction as the second side of the optical fiber, wherein optical fiber is stripped at a stripping device and is spliced to another optical fiber at the splice machine, wherein the stripping device includes a first receptacle for receiving the clip during stripping and the splicing device includes a second receptacle for receiving the clip during splicing, wherein the clip is mounted in the first receptacle during stripping of the optical fiber with the first side of the clip facing the first receptacle and the second side of the clip facing a cover for securing the clip in the first receptacle, and wherein the clip is mounted in the second receptacle during splicing with the second side of the clip facing the second receptacle and the first side of the clip facing a cover for securing the clip in the second receptacle.

7. The method of claim 6, wherein the stripping device includes a heated surface and a non-heated surface, and wherein during the stripping process the optical fiber is pressed between the heated surface and the non-heated surface with the first side of the optical fiber contacting the heated surface and the second side of the optical fiber contacting the non-heated surface.
